(19) United States
(12) Patent Application Publication
(10) Pub. No.: US 2005/0257999 A1
(43) Pub. Date: Nov. 24, 2005

(54) Bobbin integrated type magnesium diaphragm, manufacturing method thereof, and speaker device using the diaphragm

(75) Inventors: Hiroyuki Tomiyama, Tendo-shi (JP); Yuichi Kasahara, Tendo-shi (JP); Koji Matsumoto, Tendo-shi (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 11/127,322

(22) Filed: May 12, 2005

(30) Foreign Application Priority Data
May 19, 2004 (JP) 2004-148873

(51) Int. Cl. H04R 1/00; H04R 7/00

(52) U.S. Cl. 181/168; 381/412; 29/609.1; 29/594; 181/172

(57) ABSTRACT

In the rolling process, a rolling amount at each time of rolling by a rolling machine is set to 1 μm to 20 μm, and a magnesium substrate is heated by a constant temperature oven and rolled by rollers. Thus, a magnesium sheet of 30 μm to 100 μm is produced. This magnesium sheet is used to form a bobbin and a diaphragm integrally molded with each other, and the diaphragm is molded into a semi-dome shape or a dome shape. Thus, a bobbin integrated type magnesium diaphragm having the semi-dome shaped diaphragm or the dome shaped diagram is manufactured. The bobbin integrated type magnesium diaphragm is applied to a dynamic speaker device. As a result, the high-quality dynamic speaker device, which realizes high rigidity, high sensibility, high internal loss, less distortion and the like, is obtained.

### BACKGROUND OF THE INVENTION

1. Field of the Invention

The present invention relates to a bobbin integrated type diaphragm, a manufacturing method thereof, and a speaker device using the diaphragm.

2. Description of Related Art

Conventionally, materials such as aluminum and titanium are suitably used for metallic diaphragms of speakers for high-frequency reproduction. A diaphragm and a bobbin are individually molded by using these materials, and they are then bonded by adhesive. Speakers for high-frequency reproduction having a bobbin attached type diaphragm which have the above construction are known. In such speakers, however, since the diaphragm and the voice coil bobbin are bonded by using adhesive, loss of sound wave propagation occurs due to an influence of the adhesive, and thus sound characteristics vary. The aluminum and the titanium which have high heat radiation properties are used to integrally mold diaphragm and bobbin, so that a bobbin integrated type diaphragm is obtained. Speakers for high-frequency reproduction having the bobbin integrated type diaphragm which are constituted in such a manner are known.

In general, since the metallic diaphragms have higher rigidity than that of resin diaphragms, the metallic diaphragms have such physical properties that higher fh (high limit frequency) than that of the resin diaphragms can be obtained. Here, “fh” is the high limit frequency which is generated by reverse resonance of the diaphragm and an edge. For this reason, the speakers for high-frequency reproduction using the metallic diaphragm can reproduce sounds of up to high-frequency band in a less distorted state.

However, since the diaphragms using aluminum and titanium have small internal loss (tan δ), when fh is generated in an audible band of 20 Hz to 20 KHz, a peak and a dip appear greatly in the high-frequency band in comparison with the resin diaphragms, and thus sound has a lot of distortion.

In addition, since the metallic diaphragms have large mass, the efficiency that input signals are converted into output sound pressure is deteriorated, and thus sound sensibility is deteriorated. For this reason, in order to solve such problems, a method of reducing a thickness of a diaphragm to heighten the sound sensibility is adopted. However, this method has such a problem that the rigidity of the diaphragm is deteriorated, thereby easily causing unnecessary resonance, and the sounds generated via the diaphragms have a lot of distortion.

As a structure of such a diaphragm for a speaker, there is known a structure of a diaphragm for a speaker in which an outer periphery of the diaphragm is strengthened to improve the characteristics (for example, see Japanese Utility Model Publication No. 7-49906). According to this document, titanium is used as a metallic material. A dome shaped diaphragm, a coil bobbin and an edge portion formed on a lower edge of the coil bobbin are molded integrally to form a diaphragm member. The center of the diaphragm is, then, cut along a cut line so that a perforated diaphragm member is obtained, and a diaphragm center member which is formed separately is joined to its joint portion, so that the outer peripheral portion of the diaphragm has a polymeric structure. For this reason, in the speakers having such a diaphragm, the peak of the resonance in the high range is made flat.

Further, the following method of manufacturing such a speaker diaphragm (for example, see Japanese Patent No. 3148686) is known. In this method, titanium having thickness of 25 μm is press-molded to manufacture a diaphragm substrate in which a diaphragm portion, a voice coil bobbin portion and an edge portion are molded integrally. A crystalline deposition film made of a diamond film is formed on an upper surface of the diaphragm portion and over the diaphragm portion to an upper end of the coil portion so that the speaker diaphragm is manufactured. In the speaker diaphragm obtained in such a manner, since the upper end of the coil bobbin portion and the upper end of the coil portion are covered with the deposition film made of an inorganic material, an influence of adhesive upon the coil portion is eliminated, and thus an acoustic wave propagation velocity is further heightened.

### SUMMARY OF THE INVENTION

It is an object of the present invention to provide a bobbin integrated type magnesium diaphragm which is capable of realizing high rigidity, high sensibility, high internal loss and less distortion, a manufacturing method thereof, and a speaker device using the diaphragm.

According to one aspect of the present invention, there is provided a method of manufacturing a bobbin integrated type magnesium diaphragm, including: a heating process of heating a magnesium substrate; a rolling process of rolling the heated magnesium substrate to manufacture a magnesium sheet; and a molding process of molding the magnesium sheet to form a bobbin and a diaphragm integrated with each other.

By the method of manufacturing the bobbin integrated type magnesium diaphragm described above, the magnesium substrate is heated and is rolled to produce the magnesium sheet having a predetermined thickness. At this time, the magnesium substrate is heated because it is brought into an easily rolled state by the heating. Then, the produced magnesium sheet is molded, and a bobbin and a diaphragm are formed integrally, thereby the bobbin integrated type magnesium diaphragm is manufactured. Since the bobbin integrated type magnesium diaphragm obtained in such a manner is made of magnesium, it has high rigidity, high sensibility, high internal loss, light weight and less distortion.

In a mode of the method of manufacturing the bobbin integrated type magnesium diaphragm, the rolling process may repeat rolling plural times with varying a rolling amount at each time so as to manufacture the magnesium sheet having a predetermined thickness.

In this mode, the rolling amount at each time of rolling can be adjusted suitably in the rolling process. In a preferable example, the rolling amount may be 1 μm to 20 μm, and the rolling amount may be reduced stepwise as the magnesium sheet becomes thinner. At this time, as the magnesium substrate becomes thinner, the rolling amount at each time of rolling is reduced gradually, thereby preventing defects such as crack, warpage and pinhole on the rolled magnesium substrate. Therefore, the yield can be improved. Thereafter, the magnesium sheet is molded, so that the bobbin integrated type magnesium diaphragm having a desired thickness can be manufactured accurately.

In another mode of the method of manufacturing the bobbin integrated type magnesium diaphragm, the predetermined thickness may be 30 μm to 100 μm. Thereby, the bobbin integrated type magnesium diaphragm with high quality which realizes high rigidity, high sensibility, high internal loss and less distortion can be manufactured without an influence of oxidation.

In a preferred embodiment, the magnesium sheet may be molded into a semi-dome shaped, a dome shaped or a cone shaped diaphragm in the molding process. Thus, a speaker device for high-frequency reproduction or low-frequency reproduction can be manufactured.

In another aspect of the present invention, the diaphragm for speaker is made of magnesium, and the diaphragm is formed in a manner integrated with a bobbin. Further, in a preferable embodiment, the speaker diaphragm may have the thickness of 30 μm to 100 μm. In this speaker diaphragm, since the thickness is not less than 30 μm, the diaphragm is not influenced by oxidation and has characteristics such as high rigidity, high internal loss, small mass, high thermal conductivity and less distortion. Since the internal loss is high, a peak or a dip of an output sound pressure generated in high-frequency band becomes small, and thus distortion such as secondary or cubic distortion is also reduced. The output sound pressure therefore becomes flat in the high-frequency band, so that sound with high quality can be reproduced. In the bobbin integrated type magnesium diaphragm for the speaker device, since its thickness is set to not more than 100 μm, the diaphragm has light weight, and hence the sensibility can be improved while the rigidity of the bobbin or the like is maintained.

In the bobbin integrated type magnesium diaphragm for the speaker device, the bobbin and the diaphragm are formed in an integrated manner, and adhesive is not used for jointing the bobbin and the diaphragm. Since the speaker device which adopts the diaphragm is not influenced by the adhesive, a vibration of the voice coil can be propagated to the diaphragm via the bobbin without loss, and the characteristics such as sound characteristics can be prevented from varying. In addition, excretion of volatile organic compounds (VOC) can be reduced. For this reason, the safety for workers can be ensured at the time of manufacturing the speakers, and this contributes to environmental purification.

In the bobbin integrated type magnesium diaphragm for the speaker device, since the bobbin and the diaphragm are molded in an integrated manner, heat generated from the voice coil can be transmitted efficiently to the diaphragm via the bobbin, and the heat can be radiated to external space out of the speaker device, i.e., to the air. The limit value of withstand input can be set to a larger value.

In a speaker device including the bobbin integrated type magnesium diaphragm, the speaker diaphragm may be formed into a semi-dome shape, a dome shape or a cone shape, which are generally known. Thus, a speaker device for high-frequency reproduction such as a tweeter and a speaker device for low-frequency reproduction such as a woofer can be manufactured.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a diagram illustrating a rolling process of rolling a magnesium substrate to produce a magnesium sheet according to the present invention;

FIGS. 2A and 2B are tables showing various examples of rolling process for the magnesium substrate according to the present invention;

FIGS. 3A and 3B are graphs illustrating output sound pressure characteristics of a bobbin integrated type magnesium diaphragm of 30 μm and 100 μm according to the present invention;

FIGS. 4A and 4B are graphs illustrating a comparison of output sound pressure characteristics of the bobbin integrated type magnesium diaphragm according to the present invention and a bobbin integrated type titanium diaphragm;

FIGS. 5A and 5B are tables showing property parameters of magnesium, titanium and aluminum;

FIG. 6 is a table showing a relationship between thickness and rigidity of magnesium, titanium and aluminum;

FIGS. 7A and 7B are diagrams illustrating an example in which the bobbin integrated type magnesium diaphragm having a semi-dome shaped diaphragm is applied to a dynamic speaker; and

FIGS. 8A and 8B are diagrams illustrating an example in which the bobbin integrated type magnesium diaphragm having a dome shaped diaphragm is applied to a dynamic speaker.

### DETAILED DESCRIPTION OF THE PREFERRED EMBODIMENTS

Preferred embodiments of the present invention will be described below with reference to the attached drawings. According to the present invention, sheet-shaped magnesium which is rolled into the thickness of 30 μm to 100 μm is applied to the bobbin integrated type diaphragm. The bobbin integrated type magnesium diaphragm is applied to the speaker device. As a result, the high-quality speaker device, which realizes high rigidity, high sensibility, high internal loss and less distortion, can be obtained. A rolling method of rolling the magnesium substrate having predetermined thickness into the thickness of 30 μm to 100 μm, output sound pressure characteristics of the bobbin integrated type magnesium diaphragm obtained by molding the magnesium sheet in the high-frequency band, and examples in which the bobbin integrated type magnesium diaphragms of various embodiments such as the dome type and semi-dome type are applied to the speaker device are explained below.

[Rolling Method of Magnesium Substrate]

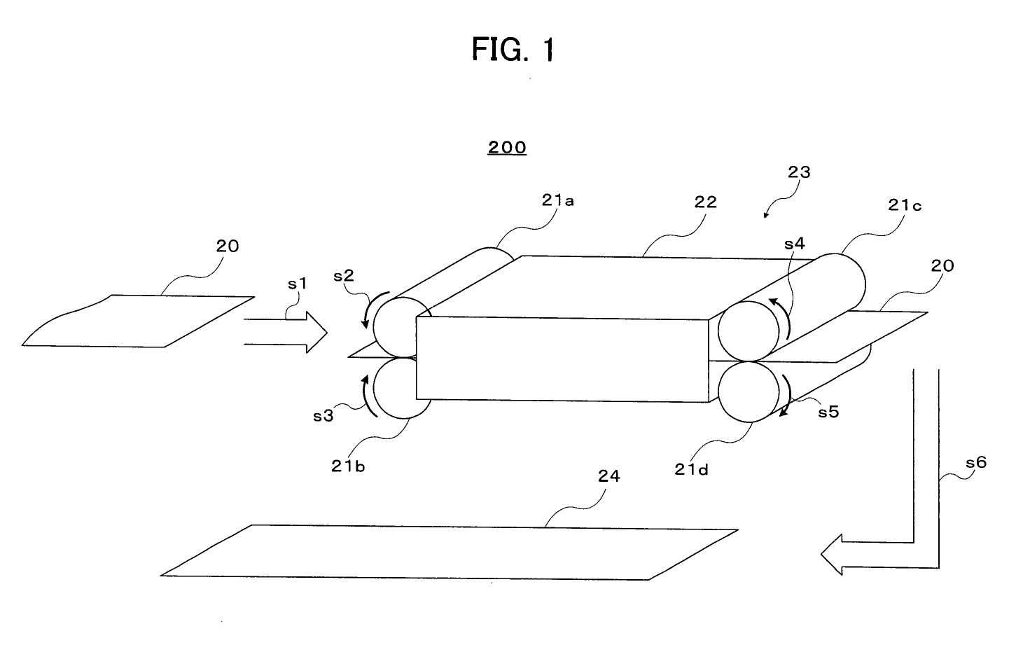

The rolling method of the magnesium substrate will be explained with reference to FIG. 1. FIG. 1 illustrates the rolling process 200 of rolling the magnesium substrate 20 into the magnesium sheet 24 of the thickness of 30 μm to 100 μm.

The magnesium substrate 20 is formed as a sheet material having a thickness of about 150 μm in advance. In the rolling process 200, the magnesium substrate 20 is rolled plural times by a rolling machine 23, so that the magnesium sheet 24 having a desired thickness within a range of 30 μm to 100 μm is produced (see an arrow s6).

The rolling machine 23 has rollers 21a, 21b, 21c and 21d which rotate in constant directions and apply constant tension to the magnesium substrate 20 so as to roll the magnesium substrate 20 into a predetermined thickness, and a constant temperature oven 22 which heats the magnesium substrate 20 to a predetermined temperature.

The rollers 21a, 21b, 21c and 21d can be adjusted to the constant tension via a tension adjusting mechanism, not shown. A worker operates an operation panel of the tension adjusting mechanism so that the tension is adjusted to be constant. In this example, the rollers 21a, 21b, 21c and 21d can thin the magnesium substrate 20 by a thickness within a range of about 1 to 20 μm at each time of rolling.

The constant temperature oven 22 is a device for heating the magnesium substrate 20 to a predetermined temperature, and its inside is controlled to have a constant temperature by a temperature adjusting mechanism, not shown. Since the magnesium is closest-packed hexagonal crystal, it is difficult to process the magnesium at room temperature. For this reason, the magnesium substrate 20 is rolled while it is being heated to normally about 200 to 400° C. by the constant temperature oven 22. Thus, the magnesium substrate 20 which is hardly plastic-deformed is brought into an easy rolled state.

The flow of the rolling process 200 will be explained below. The magnesium substrate 20 having constant thickness and length is delivered to the rolling machine 23 by a delivery device, not shown (arrow s1). While the rollers 21a and 21b are rotating in the constant directions (arrows s2 and s3), they roll the magnesium substrate 20 into a predetermined thickness and deliver the magnesium substrate 20 to the constant temperature oven 22. While the magnesium substrate 20 is passing through the constant temperature oven 22, it is heated to a predetermined temperature and becomes easy to be plastic-deformed. When the magnesium substrate 20 is delivered from the constant temperature oven 22 to the rollers 21c and 21d, the rollers 21c and 21d rotating in the constant directions (arrows s4 and s5) roll the magnesium substrate 20 again. The magnesium substrate 20 which undergoes the rolling process 200 finally becomes the magnesium sheet 24 having the thickness within the range of 30 μm to 100 μm (arrow s6).

In this embodiment, when the magnesium substrate 20 is rolled, the rolling amount at each time of rolling is set to be within the range of about 1 to 20 μm because of the following reason. Since a slip amount of the magnesium material is much smaller than that of the other metal, this material has difficulty in plastic-deforming. Therefore, when the rolling amount by one rolling process is increased too much, defects such as crack, warpage and pinhole occur in the magnesium substrate 20 due to an influence of residual distortion in the magnesium substrate 20, thereby deteriorating the yield. In this embodiment, therefore, the rolling amount at each time of rolling is reduced to about 1 to 20 μm, and the magnesium substrate 20 is rolled plural times, so that the above defect is avoided and the yield is improved.

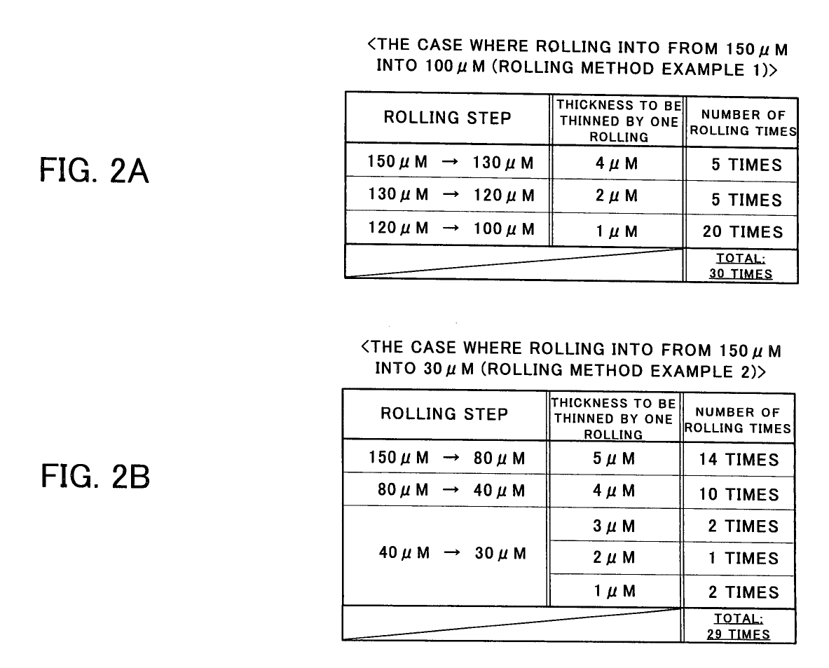

Examples of the rolling method of rolling the magnesium substrate 20 in the rolling process 200 are explained below with reference to FIGS. 2A and 2B. FIG. 2A illustrates one example of the rolling method when the magnesium substrate 20 is rolled from 150 μm to 100 μm (Rolling Method Example 1). FIG. 2B illustrates one example of the rolling method when the magnesium substrate 20 is rolled from 150 μm to 30 μm (Rolling Method Example 2).

In the rolling method example 1 shown in FIG. 2A, the magnesium substrate 20 of 150 μm is rolled finally to the thickness of 100 μm via the three rolling steps including the rolling step from 150 μm into 130 μm, the rolling step from 130 μm to 120 μm, and the rolling step from 120 μm to 100 μm. The three rolling steps are executed by the rolling machine 200.

At the first rolling step from 150 μm to 130 μm, the tension of the rollers 21a, 21b, 21c and 21d is adjusted, and the rolling amount of the magnesium substrate 20 at each time of rolling is set to 4 μm. The magnesium substrate 20 is rolled five times by the rolling machine 23, so that the magnesium substrate 20 has the thickness of 130 μm.

At the rolling step from 130 μm to 120 μm, the rolling amount of the magnesium substrate 20 at each time of rolling is set to 2 μm, and the magnesium substrate 20 is rolled five times by the rolling machine 23. As a result, the magnesium substrate 20 has the thickness of 120 μm.

At the rolling final step from 120 μm to 100 μm, the rolling amount of the magnesium substrate 20 at each time of rolling is set to 1 μm, and the magnesium substrate 20 is rolled twenty times by the rolling machine 23. As a result, the magnesium substrate 20 has the thickness of 100 μm

In the rolling method example 1 of FIG. 2A, the magnesium substrate 20 is rolled thirty times, in total, with rolling amount being varied, and the magnesium sheet 24 having the thickness of 100 μm can be obtained.

In the rolling method example 2 of FIG. 2B, the magnesium substrate 20 of 150 μm is finally rolled to the thickness of 30 μm via the three rolling steps including the rolling step from 150 μm to 80 μm, the rolling step from 80 μm to 40 μm and the rolling step from 40 μm to 30 μm.

At the first rolling step from 150 μm to 80 μm, the rolling amount of the magnesium substrate 20 at each time of rolling is set to 5 μm, and the magnesium substrate 20 is rolled fourteen times by the rolling machine 23. As a result, the magnesium substrate 20 has the thickness of 80 μm.

At the rolling step from 80 μm to 40 μm, the rolling amount of the magnesium substrate 20 at each time of rolling is set to 4 μm, and the magnesium substrate 20 is rolled ten times by the rolling machine 23. As a result, the magnesium substrate 20 has the thickness of 40 μm.

At the final rolling step from 40 μm to 30 μm, the rolling amount of the magnesium substrate 20 at each time of rolling is first set to 3 μm, and the magnesium substrate 20 is rolled twice by the rolling machine 23. As a result, the magnesium substrate 20 has the thickness of 34 μm. Then, the rolling amount of the magnesium substrate 20 at each time of rolling is set to 2 μm, and the magnesium substrate 20 is rolled once by the rolling machine 23. As a result, the magnesium substrate 20 has the thickness of 32 μm. Finally, the rolling amount of the magnesium substrate 20 at each time of rolling is set to 1 μm, and the magnesium substrate 20 is rolled twice by the rolling machine 23. As a result, the magnesium substrate 20 has the thickness of 30 μm.

In the rolling method example 2 of FIG. 2B, the magnesium substrate 20 is rolled twenty-nine times, in total, with the rolling amount being varied, and the magnesium sheet 24 having the thickness of 30 μm is obtained.

In the rolling method examples 1 and 2, the rolling amount at each time of rolling is gradually reduced in a stepwise manner at the later steps because of the following reason. The thickness of the magnesium substrate 20 becomes smaller each time when it is rolled, and this deteriorates the rigidity of the magnesium substrate 20. Thus, the defect such as crack may easily occur. For this reason, at the three rolling steps shown in FIGS. 2A and 2B, the rolling amount is reduced at the later steps to avoid the occurrence of the defect.

The rolling method examples 1 and 2 shown in FIGS. 2A and 2B are merely examples, and thus the rolling method and the rolling amount at each time of rolling are not limited to them.

The magnesium sheet 24 obtained in such a manner is molded, so that the bobbin integrated type magnesium diaphragms having various shapes such as the dome shape, the semi-dome shape and the cone shape are manufactured.

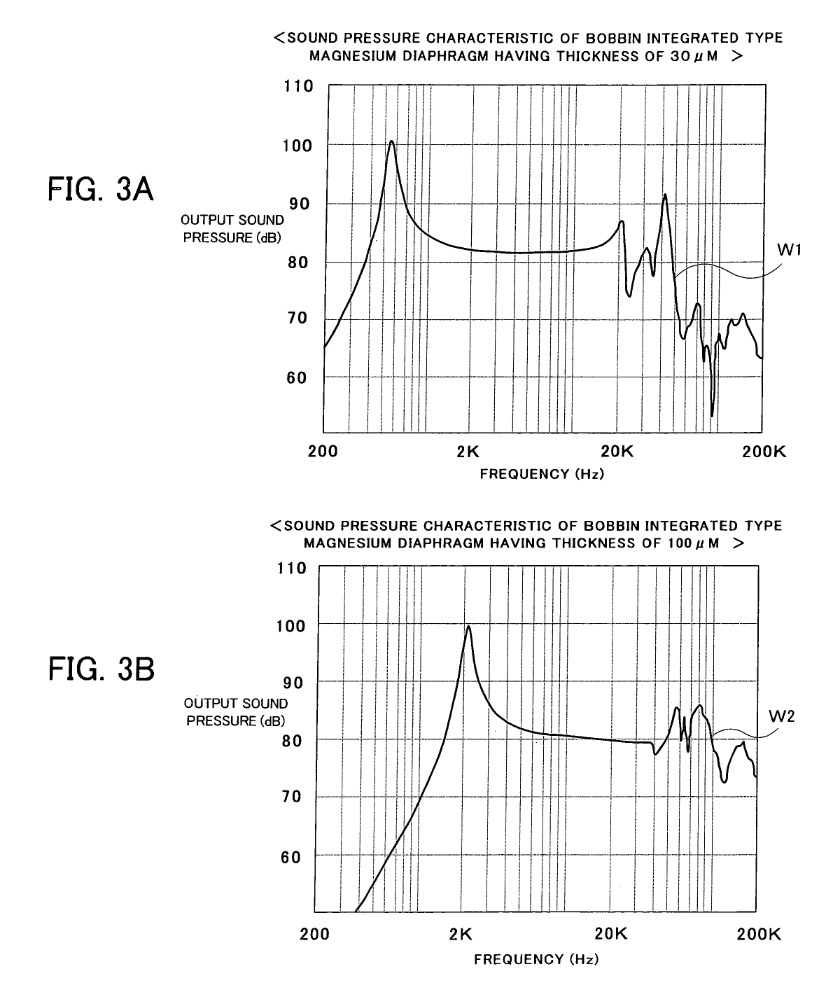

FIGS. 3A and 3B are graphs illustrating measured examples of the sound pressure characteristics in the high-frequency band of the bobbin integrated type magnesium diaphragms having the thickness of 30 μm and 100 μm rolled by the rolling process 200. In this experimental example, the sound pressure output from the bobbin integrated type magnesium diaphragm is measured when an input signal frequency is changed. The graph W1 shown in FIG. 3A shows a relationship between the input signal frequency (Hz) and the output sound pressure (dB) in the speaker device using the bobbin integrated type magnesium diaphragm having the thickness of 30 μm. The graph W2 shown in FIG. 3B shows a relationship between the input signal frequency (Hz) and the output sound pressure (dB) in the speaker device using the bobbin integrated type magnesium diaphragm having the thickness of 100 μm.

In the speaker device using the bobbin integrated type magnesium diaphragm having the thickness of 30 μm, the output sound pressure is flat in a range of about 2 KHz to 20 KHz as shown in the graph W1 of FIG. 3A. On the other hand, in the speaker device using the bobbin integrated type magnesium diaphragm having the thickness of 100 μm, the output sound pressure is flat in a range of around 10 KHz to about just before 60 KHz as shown in the graph W2 of FIG. 3B. That is, in both cases, the flat characteristics can be obtained in the high-frequency band around 3 KHz to 20 kHz which is required by the speaker device for high-frequency reproduction. Although the bobbin integrated type magnesium diaphragms having the thickness of 30 μm and 100 μm use the same magnesium material, they have different output sound pressure characteristics. This is because their masses are different even when they have the same shape and the same size, and hence the output sound pressure characteristics are also different.

Further, in the bobbin integrated type magnesium diaphragms having the thickness of 30 μm and 100 μm, since a peak (crest of a specified frequency) is not generated in an audible band, a sound in the high-frequency band can be reproduced with less distortion.

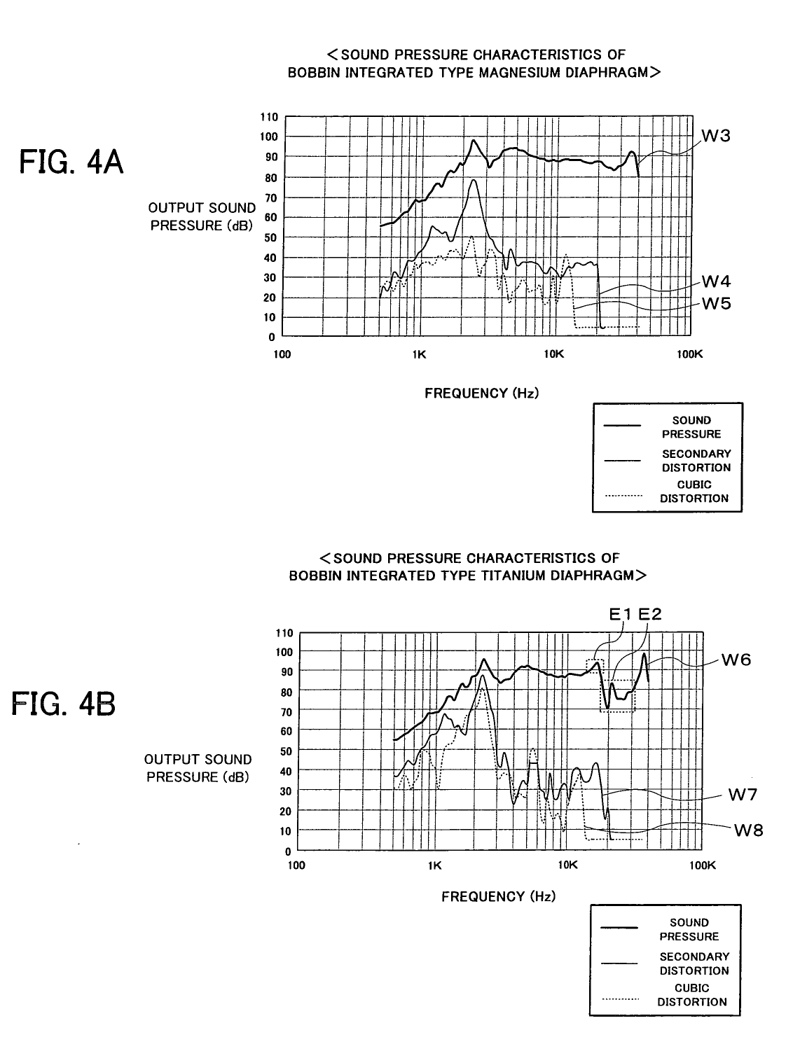

FIGS. 4A and 4B are graphs of the output sound pressure characteristics in the high-frequency band of the bobbin integrated type magnesium diaphragm and the bobbin integrated type titanium diaphragm, for comparison. Graphs W3 and W6 show the output sound pressure (thick solid line), graphs W4 and W7 show secondary distortion (thin solid line), and graphs W5 and W8 show cubic distortion (broken line). FIG. 4A illustrates the characteristics of the speaker device to which the bobbin integrated type magnesium diaphragms having the thickness of 30 μm to 100 μm is applied.

In the bobbin integrated type magnesium diaphragm, as shown in the graph W3 of FIG. 4A, the output sound pressure is flat from about 3.5 KHz to about 30 KHz. On the other hand, in the bobbin integrated type titanium diaphragm, as shown in the graph W6 of FIG. 4B, the output sound pressure is flat from about 4 KHz to about 15 KHz. The sound reproduction band of the bobbin integrated type magnesium diaphragm is wider than that of the bobbin integrated type titanium diaphragm in the high frequency band, and the bobbin integrated type magnesium diaphragm can reproduce sounds in ultra high frequency band.

That is, as understood with reference to the graphs W3 and W6, the output sound pressure of the bobbin integral magnesium diaphragm is flat in the audible band of around 18 KHz, but a peak is generated in a broken line area E1 (about 18 KHz) in the bobbin integrated type titanium diaphragm. Further, in the range of 18 KHz to 30 KHz, as understood with reference to the graphs W3 and W6, the output sound pressure of the bobbin integrated type magnesium diaphragm is flat, but a lot of peaks and dips (crest and trough of a specified frequency) are generated in the bobbin integrated type titanium diaphragm (see broken line area E2). The bobbin integrated type magnesium diaphragm is therefore more suitable as the diaphragm for high-frequency reproduction than the bobbin integrated type titanium diaphragm.

FIGS. 4A and 4B show secondary and cubic distortion characteristics as graphs. Particularly, when the secondary distortion characteristics are compared between the bobbin integrated type magnesium diaphragm and the bobbin integrated type titanium diaphragm in the audible band of 3 KHz to 20 KHz, as understood with reference to the graphs W4 and W7, more peaks and dips are generated in the bobbin integrated type titanium diaphragm. Further, when the cubic distortion characteristics are compared in the similar band between the bobbin integrated type magnesium diaphragm and the bobbin integrated type titanium diaphragm, as understood from the graphs W5 and W8, a difference in the output sounds between the peak and the dip is larger in the bobbin integrated type titanium diaphragm.

This indicates that the bobbin integrated type titanium diaphragm contains more distortion components than the bobbin integrated type magnesium diaphragm in the high-frequency band. The bobbin integrated type magnesium diaphragm is therefore more suitable as the diaphragm for high-frequency reproduction than the bobbin integrated type titanium diaphragm.

When the bobbin integrated type magnesium diaphragm is compared with a bobbin integrated type aluminum diaphragm which is not particularly described in this embodiment, a lot of peaks and dips are generated in the bobbin integrated type aluminum diaphragm in the high-frequency band, and it contains large distortion components. The bobbin integrated type magnesium diaphragm is therefore more suitable as the diaphragm for high-frequency reproduction than the bobbin integrated type aluminum diaphragm.

The above-mentioned characteristics appear mainly due to the physical properties such that magnesium has higher internal loss, smaller mass, higher sonic speed and higher rigidity than titanium and aluminum.

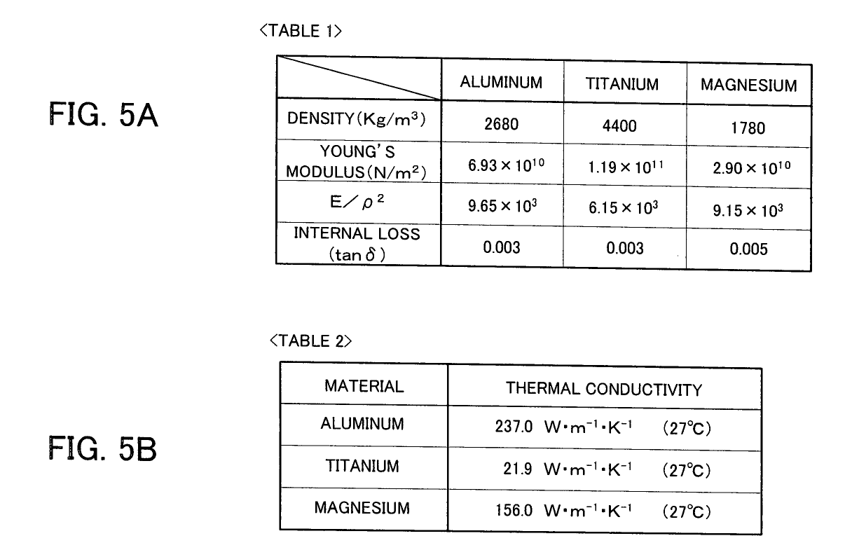

With reference to Table 1 of FIG. 5A, the internal loss (tan δ), the density ρ and “E/ρ²” of magnesium, titanium and aluminum are actually compared and examined. “E/ρ²” is obtained by dividing Young's modulus E by the square of the density ρ, and it can be roughly considered to represent a speed (sonic speed) of the diaphragm.

As shown in Table 1, the internal loss of magnesium is 0.005, and the internal loss of titanium and aluminum is 0.003. The internal loss of magnesium is therefore larger than that of titanium and aluminum. For this reason, in the speaker device to which the bobbin integrated type magnesium diaphragm of the present invention is applied, a peak and a dip to be generated at the time of unnecessary resonance can be reduced, and the sound quality with less distortion can be obtained.

The density ρ of magnesium, titanium and aluminum is compared and examined. As shown in Table 1, the density of magnesium ρ is 1780 (Kg/m³), the density ρ of titanium is 4400 (Kg/m³), and the density ρ of aluminum is 2680 (Kg/m³) Therefore, Magnesium has smaller mass than that of titanium and aluminum. For this reason, in the speaker device to which the bobbin integrated type magnesium diaphragm of the present invention is applied, the sensibility can be increased with the rigidity maintained.

As shown in Table 1, E/ρ² of the magnesium diaphragm is 9.15×10³, E/ρ² of the aluminum diaphragm is 9.65×10³, and E/ρ² of the titanium diaphragm is 6.15×10³. E/ρ² of the magnesium diaphragm is therefore approximately equal to E/ρ² of the aluminum diaphragm, and thus the sonic speed is high. For this reason, the speaker device to which the bobbin integrated type magnesium diaphragm of the present invention is applied quickly responds to sounds (i.e., having good transient characteristic), and thus the reproduction characteristic in the high-frequency band is good.

A relationship between the sensibility of the speaker and the speaker materials is examined. The sensibility (dB) of the speaker is represented by the following formula:
SPL(dB)=20 log₁₀{P/(2×10⁻⁵)} (Formula-1)

Further, the sound pressure P (Pa) in the right-hand side of the Formula-1 is represented by the following formula:
P=(jω×ρo×V×Sp)/2τr (Formula-2),
wherein “jω” is an angular speed, “ρo” is an air density, “V” is a speed of the diaphragm, “Sp” is an effective area of the diaphragm, and “r” is a distance up to a measurement microphone.

A change in the sensibility of the speaker according to the weight of the diaphragm is examined by changing the metal material applied to the diaphragm. For this reason, when attention is paid to the velocity of the diaphragm V in the Formula-2, the velocity of the diaphragm V is represented by the following formula:
V=F/Zm (Formula-3),
wherein “F” is a force generated in the voice coil and “Zm” is a mechanical impedance. The mechanical impedance Zm is represented by the following formula:
Zm=Rm+j(ωmo−1/ωC) (Formula-4),
wherein “Rm” is a mechanical resistance, “C” is a compliance, and “mo” is a weight of a vibration system.

Since the mechanical resistance Rm and the compliance C in the Formula-4 can be ignored in the middle and high frequency bands, an approximate value of Zm is jωmo, i.e., Zm=jωmo. As a result, between the speakers having the same mechanism and the diaphragm of the same volume, the sensibility of the speaker varies according to a difference in the gravity of materials of the diaphragms.

When magnesium is used as the material of the diaphragm, it is assumed that the weight of the vibration system is expressed by mo1, the mechanical impedance is expressed by Zm1, the velocity of the diaphragm is expressed by V1, the sound pressure is expressed by P1, and the sensibility of the speaker is expressed by SPL1. When aluminum is used as the material of the diaphragm, it is assumed that the weight of the vibration system is expressed by mo2, the mechanical impedance is expressed by Zm2, the velocity of the diaphragm is expressed by V2, the sound pressure is expressed by P2, and the sensibility of the speaker is expressed by SPL2. Further, when titanium is used as the material of the diaphragm, it is assumed that the weight of the vibration system is expressed by mo3, the mechanical impedance is expressed by Zm3, the velocity of the diaphragm is expressed by V3, the sound pressure is expressed by P3, and the sensibility of the speaker is expressed by SPL3. It is assumed that all the diaphragms have the same volume.

In the above case, since the weight of the diaphragm system has a relationship: mo3>mo2>mo1, the mechanical impedance Zm has a relationship Zm3>Zm2>Zm1 according to the Formula-4. Therefore, the velocity of the diaphragm V has a relationship: V1>V2>V3 according to the Formula-3, and the sound pressure P has a relationship: P1>P2>P3 according to the Formula-2. Therefore, the sensibility of the speaker SPL has a relationship: SPL1>SPL2>SPL3 according to the Formula-1. Under the above conditions, the sensibility of the speaker is higher in order of the speaker having the magnesium diaphragm, the speaker having the aluminum diaphragm and the speaker having the titanium diaphragm.

These results indicate that lightening the weight of the diaphragm is necessary to improve the sensibility of the speaker. As described above, aluminum and titanium have larger density ρ than that of magnesium. Therefore, when the bobbin integrated type diaphragm is manufactured by using aluminum and titanium, it is necessary to reduce the thickness to prevent the sensibility of the speaker being deteriorated. However, if the thickness is reduced, the rigidity E·t³ of the bobbin which needs the strength is reduced. Therefore, in order to increase the rigidity of the bobbin and the sensibility of the speaker, magnesium whose gravity is smaller than that of the aluminum and titanium is the most suitable as the material to be used for manufacturing the bobbin integrated type diaphragm.

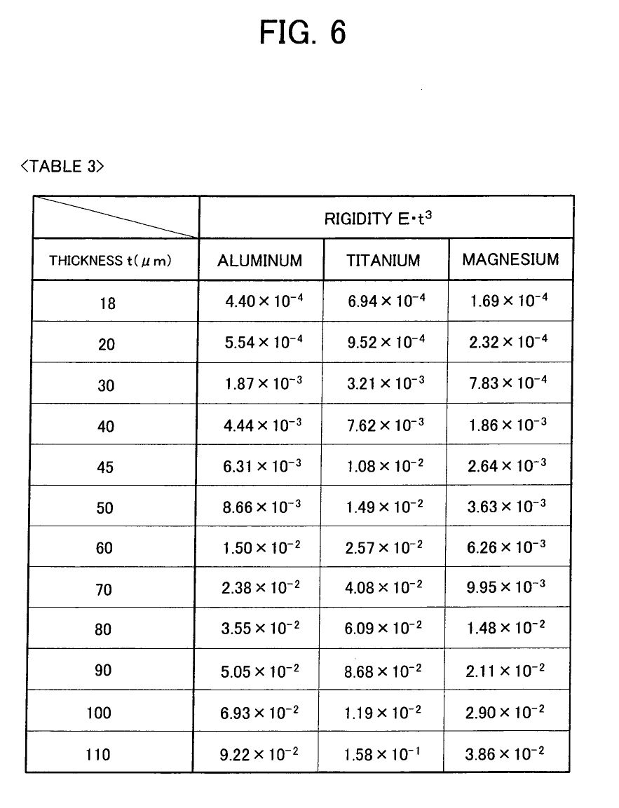

For example, in order to achieve the sensibility which is the same as that of the speaker having the aluminum diaphragm with thickness of 30 μm, theoretically it is necessary to set the thickness of the magnesium diaphragm to 45 μm and the thickness of the titanium diaphragm to 18 μm. Results of calculating the rigidity E t³ with respect to the thickness of the diaphragms are obtained as shown in Table 3 of FIG. 6. Here, “E” is Young's modulus, and “t” is the thickness of the diaphragm. As shown in Table 3, the rigidity of the aluminum diaphragm having the thickness of 30 μm is 1.87×10⁻³, the rigidity of the magnesium diaphragm having the thickness of 45 μm is 2.64×10⁻³, and the rigidity of the titanium diaphragm having the thickness of 18 μm is 6.94×10⁻⁴. Under the condition that the speakers have the same sensibility, the rigidity is higher in order of the magnesium diaphragm, the aluminum diaphragm and the titanium diaphragm.

Since magnesium has smaller mass than that of aluminum and titanium, the bobbin integrated type diaphragm can be made thick to increase the rigidity. That is, when the thickness is increased in order to increase the rigidity, even if the increase in the weight due to the increased thickness is taken into consideration, the weight of the magnesium diaphragm can be lighter than that of the bobbin integrated type aluminum and titanium diaphragms having the same rigidity. Therefore, the weight can be lightened without deteriorating the sensibility of the speaker.

By applying the bobbin integrated type magnesium diaphragm of the present invention to the speaker device, the following effects can be further obtained.

Since a heat radiation effect becomes high, the limit value of the withstand input can be set to a higher value. Actually, the thermal conductivity values of magnesium, titanium and aluminum are compared and examined with reference to Table 2 of FIG. 5B. As shown in Table 2, the thermal conductivity of magnesium is 156.0 W m⁻¹ K⁻¹, the thermal conductivity of titanium is 21.9 W m⁻¹ K, and the thermal conductivity of aluminum is 237.0 W m⁻¹ K⁻¹. It is noted that these values are obtained when the temperature is 27° C. Aluminum has the highest thermal conductivity in those metals, and thus its radiation property is more excellent than that of magnesium. As mentioned above, however, magnesium has the larger internal loss than that of aluminum and titanium. Therefore, when not only the thermal conductivity but also the internal loss is taken into consideration, magnesium is more suitable as the diaphragm for high-frequency reproduction than aluminum. In addition, in the bobbin integrated type magnesium diaphragm of the present invention, the bobbin and the diaphragm are formed integrally. For this reason, the heat generated in the voice coil can be efficiently transmitted to the diaphragm via the bobbin, and the heat can be radiated to an external space out of the speaker device, i.e., into the air. Thus, the above effect can be achieved.

Further, the characteristics such as sound characteristic can be prevented from varying, and the vibration of the voice coil can be transmitted to the diaphragm without loss. In the bobbin integrated type magnesium diaphragm of the present invention, since the bobbin and the diaphragm are formed integrally, adhesive is not used to joint the bobbin and the diaphragm. Since the speaker device to which the diaphragm is applied is therefore not influenced by adhesive, the above effect can be obtained.

Excretion of volatile organic compounds (VOC) included in the adhesive can be reduced. This is because adhesive is not used when the bobbin integrated type magnesium diaphragm of the present invention is manufactured, namely, the bobbin and the diaphragm are jointed. For this reason, the safety of a worker can be ensured at the time of manufacturing the speaker, and this can contribute to environmental purification.

Particularly in this embodiment, since the thickness of the bobbin integrated type magnesium diaphragm is within the range of 30 μm to 100 μm, the following effect is further obtained.

That is, when the thickness becomes not more than 30 μm, the bobbin integrated type magnesium diaphragm is generally influenced by an oxide film so that its hardness increases, and the physical properties unique to magnesium such as high internal loss are deteriorated. This can be avoided. A lower limit of the thickness of the bobbin integrated type magnesium diaphragm is 30 μm due to abnormal crystal growth at the time of rolling. When the thickness is not less then 100 μm, the mass of the bobbin integrated type magnesium diaphragm increases, and hence the efficiency of the speaker is deteriorated. This can be avoided. The bobbin integrated type magnesium diaphragm of this embodiment is therefore hardly influenced by the oxidation, the high internal loss can be maintained, and less distortion can be realized without deteriorating the sensibility. For this reason, high quality sound can be reproduced in the high-frequency band.

When the effective area of the diaphragm portion in the bobbin integrated type magnesium diaphragm is enlarged, a high-range limit frequency fh is generated in the audible band, and thus the sound includes a lot of distortion. However, since the diaphragm for high-frequency reproduction is generally formed into the dome shape or semi-dome shape as will be explained below and the effective area of the diaphragm is reduced, such a defect is eliminated.

[Speaker Device Using Bobbin Integrated Type Magnesium Diaphragm]

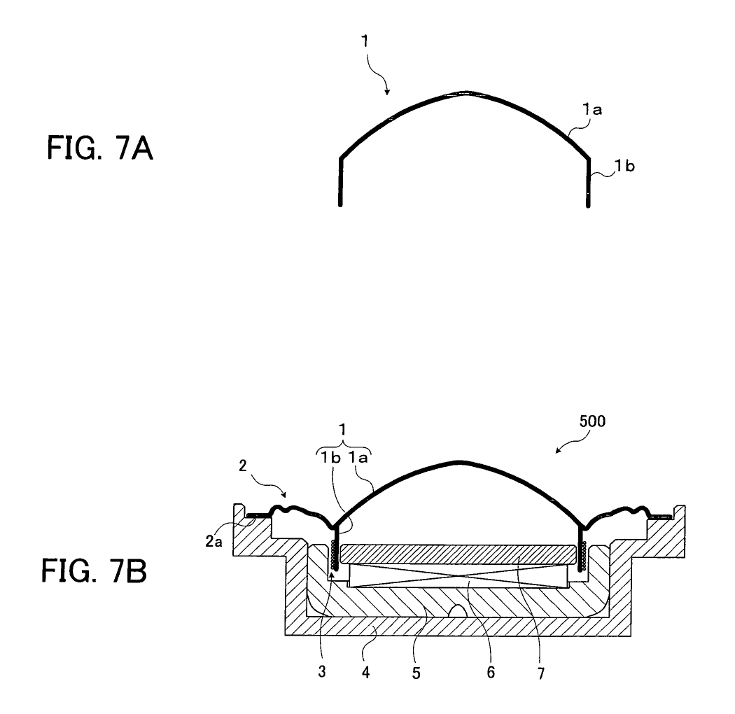

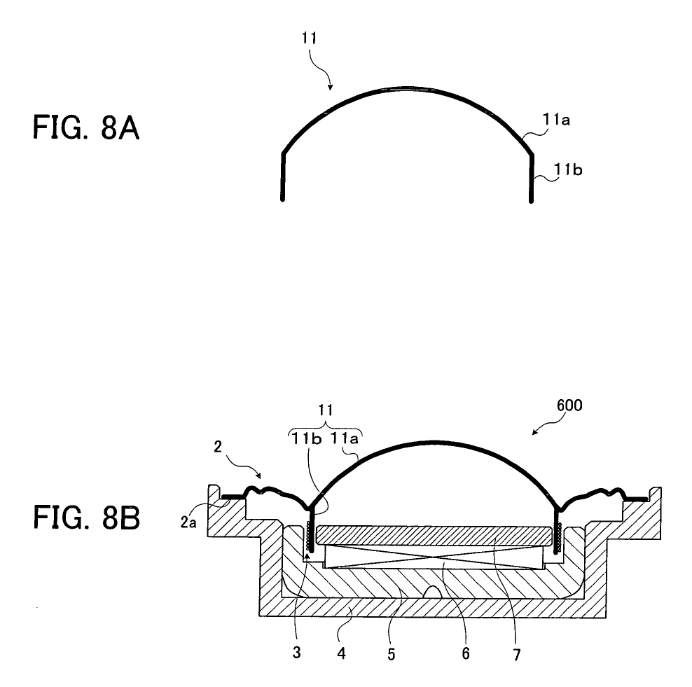

FIGS. 7A to 8B illustrate various embodiments in which the bobbin integrated type magnesium diaphragms having thickness of 30 μm to 100 μm manufactured by the rolling process are applied to the dynamic speaker device capable of high frequency reproduction. The shapes of the bobbin integrated type magnesium diaphragm in the embodiments are obtained by molding the magnesium sheet 24 manufactured by the rolling process using a press machine or the like, but the molding method is not the characteristic part of the present invention, and known various methods can be applied. The explanation thereof is therefore omitted.

(Application to Semi-Dome Shaped Dynamic Speaker Device)

FIG. 7A is a sectional view illustrating the bobbin integrated type magnesium diaphragm 1 having a semi-dome shaped diaphragm 1a and a bobbin 1b. FIG. 7B is a sectional view illustrating one example in which the bobbin integrated type magnesium diaphragm 1 is applied to the dynamic speaker device.

The basic structure and the basic principle of the semi-dome shaped dynamic speaker device 500 are explained with reference to FIG. 7B. The semi-dome shaped dynamic speaker device 500 has, as shown in FIG. 7B, the vibration system including the bobbin integrated type magnesium diaphragm 1, an edge 2 and a voice coil 3, and a magnetic circuit system including a pot york 5, a magnet 6 and a plate 7.

The bobbin integrated type magnesium diaphragm 1 is molded so that the semi-dome shaped diaphragm 1a and the bobbin 1b having approximately cylindrical shape are integrated with each other. The semi-dome shaped diaphragm 1a is an approximately hemispherical (so-called semi-dome) diaphragm having an opening on the side of the speaker. An inner peripheral edge of the edge 2 is attached to an outer peripheral edge of the semi-dome shaped diaphragm 1a. An outer peripheral edge 2a of the edge 2 is fixed to one upper end surface of the resin plate 4, serving as a housing, along a peripheral direction of the speaker. The voice coil 3 is wound around a lower end of the outer peripheral wall of the bobbin 1b.

The outer peripheral wall of the bobbin 1b is opposed, with a constant interval, to the inner peripheral wall of the approximately cylindrical pot yoke 5 having the opening on its upper surface. On the other hand, the inner peripheral wall of the bobbin 1b is opposed, with constant intervals, to an outer peripheral wall of the disc-shaped magnet 6 and an outer peripheral wall of the disc-shaped plate 7 having a diameter slightly larger than the magnet 6. As a result, a magnetic gap is formed between the outer peripheral wall of the plate 7 and the inner peripheral wall of the pot yoke 5.

In the semi-dome shaped dynamic speaker device 500 having the above structure, when a sound current flows in the voice coil 3 in the uniform magnetic field, the bobbin integrated type magnesium diaphragm 1 vibrates up and down in an axial direction of the speaker due to the principle of electromagnetic effect. As a result, a sound wave is radiated from the semi-dome shaped diaphragm 1a.

(Application to Dome Shaped Dynamic Speaker Device)

FIG. 8A is a sectional view illustrating the bobbin integrated type magnesium diaphragm 11 having a dome shaped diaphragm 11a and a bobbin 11b. FIG. 8B is a sectional view illustrating one example in which the bobbin integrated type magnesium diaphragm 11 is applied to a dynamic speaker device.

A dome shaped dynamic speaker device 600 has the approximately similar structure to that of the semi-dome shaped dynamic speaker device 500. Therefore, the same components as those in the semi-dome shaped dynamic speaker device 500 are designated by the same reference numerals, and the explanation thereof is omitted. The former and the latter have different shapes of the bobbin integrated type magnesium diaphragm. That is, the bobbin integrated type magnesium diaphragm 11 is constituted so that the dome shaped diaphragm 11a and the approximately cylindrical bobbin 11b are molded integrally. In this way, not only the semi-dome shaped bobbin integrated type magnesium diaphragm 1 but also the dome shaped bobbin integrated type magnesium diaphragm 11 can be applied to the dynamic speaker device.

[Modified Example]

In the above embodiments, the bobbin integrated type magnesium diaphragm 1 having the semi-dome shaped diaphragm 1a or the bobbin integrated type magnesium diaphragm 11 having the dome shaped diaphragm 11a is applied to the dynamic speaker device. The present invention, however, is not limited to this, and the bobbin integrated type magnesium diaphragm having a cone shaped diaphragm can be applied to the dynamic speaker device. In this case, in order to maintain the strength of the diaphragm and the bobbin against vibration at the time of reproducing bass sound, it is preferable that the bobbin integrated type magnesium diaphragm is molded into a thickness of not less than 100 μm. Further, besides the cone shaped diaphragm, bobbin integrated type magnesium diaphragms having diaphragms of various shapes can be applied to the dynamic speaker device.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2004-148873 filed on May 19, 2004 including the specification, claims, drawings and summary is incorporated herein by reference in its entirety.

1. A method of manufacturing a bobbin integrated type magnesium diaphragm, comprising:
a heating process of heating a magnesium substrate;
a rolling process of rolling the heated magnesium substrate to produce a magnesium sheet; and
a molding process of molding the magnesium sheet to form a bobbin and a diaphragm integrated with each other.

2. The method of manufacturing the bobbin integrated type magnesium diaphragm according to claim 1, wherein the rolling process repeats rolling plural times with varying a rolling amount at each time so as to produce the magnesium sheet having a predetermined thickness.

3. The method of manufacturing the bobbin integrated type magnesium diaphragm according to claim 2, wherein the predetermined thickness ranges from 30 μm to 100 μm.

4. The method of manufacturing the bobbin integrated type magnesium diaphragm according to claim 2, wherein the rolling amount ranges from 1 μm to 20 μm, and wherein the rolling amount is reduced stepwise as the magnesium sheet becomes thinner.

5. The method of manufacturing the bobbin integrated type magnesium diaphragm according to claim 1, wherein the magnesium sheet is molded into a semi-dome shaped, a dome shaped or a cone shaped diaphragm in the molding process.

6. A diaphragm for speaker made of magnesium, wherein the diaphragm is formed in a manner integrated with a bobbin made of magnesium.

7. The diaphragm for speaker according to claim 6, wherein thickness of the diaphragm and the bobbin ranges from 30 μm to 100 μm.

8. A speaker device comprising a diaphragm and a bobbin made of magnesium, wherein the diaphragm is formed in a manner integrated with the bobbin.
